(19) United States
(12) Patent Application Publication
(10) Pub. No.: US 2009/0010347 A1
(43) Pub. Date: Jan. 8, 2009

(54) TDS-OFDMA Communication Open-Loop Power Control

(75) Inventors: LIN YANG, Fremont, CA (US); Qin Liu, Fremont, CA (US)

Correspondence Address: FRANK F. TIAN, 331-4A THIRD AVENUE, LONG BEACH, NJ, 07740, US

(73) Assignee: LEGEND SILICON CORP., Fremont, CA (US)

(21) Appl. No.: 12/143,324

(22) Filed: Jun. 20, 2008

Related U.S. Application Data
(60) Provisional application No. 60/947,639, filed on Jul. 2, 2007.

(51) Int. Cl. H04L 27/28

(52) U.S. Cl. 375/260

(57) ABSTRACT

In a TDS-OFDM communications system, within a frame time, a transmitted signal comprising a preamble, a downlink sub-frame, and an uplink sub-frame. Within the downlink sub-frame, interposed between sub-frames are guard intervals comprising known sequences. The known sequences are used for an estimation of a received power. A method comprising the step of using a guard sequence in a guard interval of OFDM symbols of the received TDS-OFDM signals in the downlink to estimate a received signal power or an interference power is provided.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-070.

U.S. patent application Ser. No. ______ with attorney docket number LSFFT-072.

U.S. patent application Ser. No. ______ with attorney docket number LSFFT-069.

### REFERENCE TO RELATED APPLICATIONS

This application claims an invention which was disclosed in Provisional Application Number 60/947,639, filed Jul. 2, 2007 entitled “TDS-OFDMA Communication Open-Loop Power Control”. The benefit under 35 USC §119(e) of the United States provisional application is hereby claimed, and the aforementioned application is hereby incorporated herein by reference.

### FIELD OF THE INVENTION

The present invention relates generally to an application in a TDS-OFDMA (Time Domain Synchronous-Orthogonal Frequency Division Multiple Access) system, more specifically the present invention relates to TDS-OFDMA Communication system.

### BACKGROUND

TDS-OFDM (Time Domain Synchronous-Orthogonal Frequency Division Multiplexing) scheme is known. The scheme can be applied to both downlink and uplink wireless communications in a multiple access context. TDS-OFDM use known sequences within the guard intervals. Therefore, it is desirable to use the known sequences within the guard intervals for TDS-OFDMA Communication Open-Loop Power Control.

### SUMMARY OF THE INVENTION

In a TDS-OFDMA Communication System, known sequences within the guard intervals is used for wireless communication open-loop power control.

In a TDS-OFDM communications system, within a frame time, a transmitted signal comprising a preamble, a downlink sub-frame, and an uplink sub-frame. Within the downlink sub-frame, interposed between OFDM symbols are guard intervals comprising known sequences. The known sequences are used for an estimation of a received power.

A method comprising the step of using a guard sequence in a guard interval of OFDM symbols of the received TDS-OFDM signals in the downlink to estimate a received signal power or an interference power is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a TDS-OFDMA system in accordance with some embodiments of the invention.

FIG. 2 is an example of a novel frame structure for a TDS-OFDMA Communication System in accordance with some embodiments of the invention.

FIG. 3 is an example of an open-loop power control for initial access terminals.

FIG. 4 is an example of an open-loop power control for normal operations.

FIG. 5 is an example of a flowchart for open-loop power control on initial access terminals.

FIG. 6 is an example of a flowchart for open-loop power control during normal operations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to using known sequences within the guard intervals is used for wireless communication open-loop power control in a TDS-OFDMA Communication System for wireless communication. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of using known sequences within the guard intervals being used for wireless communication open-loop power control in a TDS-OFDMA Communication System. The non-processor circuits may include, but are not limited to, a radio receiver, a radio transmitter, signal drivers, clock circuits, power source circuits, and user input devices. As such, these functions may be interpreted as steps of a method to perform using known sequences within the guard intervals being used for wireless communication open-loop power control in a TDS-OFDMA Communication System. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

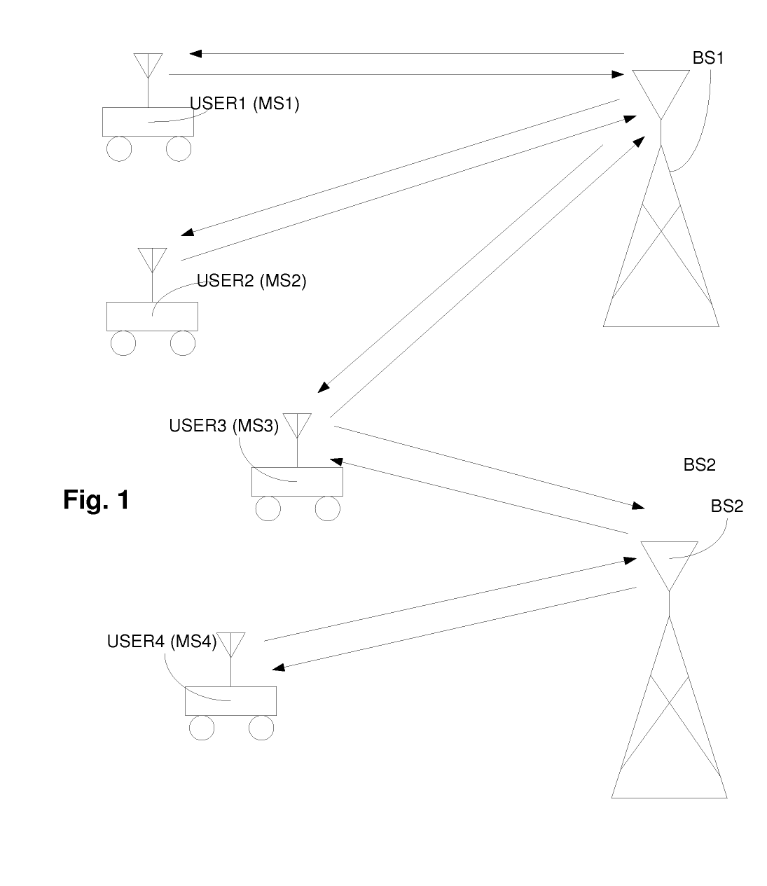

Referring to FIG. 1, a TDS-OFDM scheme 100 is applied to both downlink and uplink wireless communication. A plurality of users or mobile stations (only four, i.e. User1, User2, User3, and User4 are shown) associated with a plurality of base stations (only two, i.e. BS1 and BS2 are shown) are uplinked and down-linked for multiple accesses.

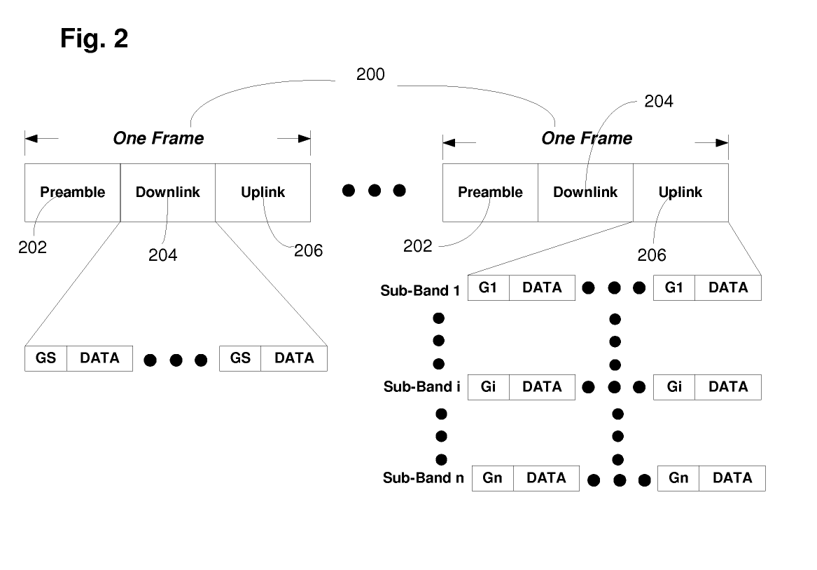

Referring to FIG. 2, a novel frame 200 structure for a TDS-OFDMA Communication System is shown. A transmission comprises a multiplicity of frames 200 is provided. For any one frame 200, there is included a preamble 202 portion, a downlink 204 portion, and an uplink 206 portion.

In a frame 200, the first set of symbols is used as the preamble 202 for synchronization and channel estimation purposes. The preamble 202 symbols can be constructed in many ways, such as a PN sequence, a frequency-domain PN sequence, or a frequency-domain segmented PN sequence similar to an IEEE 802.16 scheme. The preamble 202 positions can be at the first several symbol locations, at middle locations, or at distributed locations. The positions that are other than preamble 202 symbols are normal data symbols. The data symbols are formed of a guard interval and a data interval. The guard interval is a PN or known sequence and the data part is an OFDM symbol.

In the downlink 204, a TDS-OFDM signal is transmitted or broadcasted from, for example, transmitters of a base station. Each terminal listens to the channel and receives its own information through various ways, such as assigned time-frequency slots or connection ID, etc.

The downlink 204 signal is transmitted in a frame 200 based (transmitted frame 200 by frame 200) manner. In each frame 200, the transmitted signal is composed of multiple OFDM symbols. Each OFDM symbol comprises a PN or known sequence acting as the guard interval and a data portion as shown. When frequency reuse factor=1, the guard sequence and OFDM data may occupy the whole or part of an available bandwidth. The guard sequence and OFDM data may use the corresponding bandwidth. In the case where the frequency reuse factor is larger than 1, the available bandwidth is divided into more than 1 sub-band (not shown, but see Uplink 206 portion for sub-band depiction).

The sub-carriers in each sub-band may be contiguous where all the sub-carriers are adjoined and grouped together, or distributed where the sub-carrier may not necessary be adjoined and may be at any position inside the whole available band. The guard sequence and OFDM data may occupy the whole or a part of the assigned sub-bandwidth.

In the uplink 206, TDS-OFDM can also be used to achieve through sub-channelization, where the full-band is divided into multiple sub-bands, which means each user uses a portion of the available bandwidth and transmission time, to thereby achieve orthogonal, multiple access. The radio resource allocation is given by decoding the uplink map in the downlink 204 signal or by using the pre-assigned dedicated channels. The sub-carriers in each sub-band may be contiguous where all the sub-carriers are joined (adjacent) and grouped together, or distributed where the sub-carrier may not necessary be joined and may be at any position inside the available band.

Inside each sub-band, a TDS-OFDM signal is transmitted, which comprises a series of OFDM signals, where a PN or known guard sequence is used as the guard interval of each OFDM signal. Both the guard sequence and data signals are band-limited inside the sub-band to avoid the interference to other sub-bands.

In a frame 200, control information and radio resource management information are transmitted inside the data symbol. The control information provides the control of both downlink 204 and uplink 206. The radio resource management information provides radio resource allocation of both downlink 204 and uplink 206. Both control and radio resource management (RRM) information can be transmitted through assigned, dedicated channel or through downlink 204 map and uplink 206 map link as seen in the IEEE 802.16 scheme.

As can be seen, a TDS-OFDM communication system, wherein both uplink and downlink use TDS-OFDM signals is provided. Within a frame time, the transmitted signal is composed of a preamble, a downlink sub-frame, and an uplink sub-frame. The preamble may comprise one or several symbols. Furthermore, the preamble may be positioned at the front, the middle, or the last portion of the frame. Alternatively, the preamble may be distributed within the frame. The preamble symbol may be constructed by a time-domain PN sequence, a frequency-domain PN sequence, or partial-band frequency-domain PN sequence. Both the downlink and uplink sub-frame consists of multiple OFDM symbols. A downlink OFDM symbol comprises a guard interval and a data part, where the guard sequence is a time-domain PN sequence or other known sequence. For schemes having frequency reuse factor equal to 1, the guard sequence and OFDM data may occupy whole or partial available bandwidth. For frequency reuse factor larger than 1, the available bandwidth is divided into more than 1 sub-bands, where the sub-carriers in each sub-band may be contiguous where all the sub-carriers are adjoined and grouped together, or distributed where the sub-carrier may not be necessary be adjoined and may be at any position inside the available band. The guard sequence and OFDM data may occupy whole or partial assigned sub-bandwidth. In an uplink, the bandwidth is divided into multiple sub-bands. Where the sub-carriers in each sub-band may be contiguous where all the sub-carriers are adjoined and grouped together, or distributed where the sub-carrier may not be necessary be jointed and may be at any position inside the available band. Each user may use the radio resource allocated in time-frequency domain. The transmitted signal in each sub-band is composed of multiple OFDM symbols, where each OFDM symbol consists of a guard sequence and data. Both the guard sequence and data are band-limited to the assigned sub-band.

For the present invention, at least some OFDM symbols consist of a guard interval portion and a data portion. The guard interval may have pseudo noise (PN) sequences located therein. It is noted that the present invention contemplates using the PN sequence as guard intervals disclosed in U.S. Pat. No. 7,072,289 to Yang et al which is hereby incorporated herein by reference. However, other types of guard intervals are contemplated by the present invention as well. Inside the bandwidth for each user, at least one PN or known sequence is used as the guard interval between transmitted symbols, where the sequence is limited inside the sub-band.

The power control is needed both during the initial network access period and normal operation time period. In some cases, close-loop power control is not available or undesired, and open-loop power control is needed. For close-loop power control, see U.S. patent application Ser. No. ______ with attorney docket number LSFFT-069.

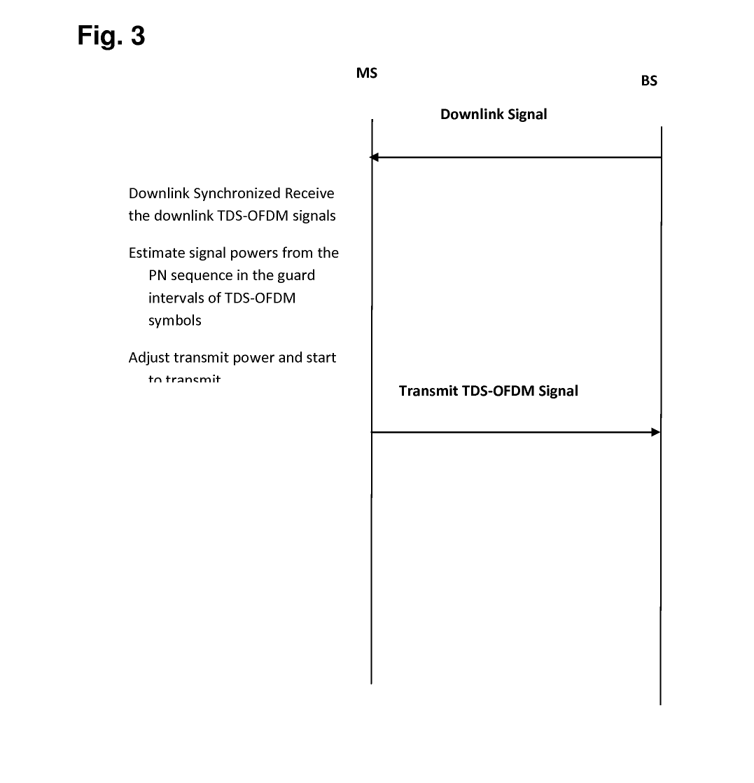

Referring to FIG. 3, open-loop power control for initial access terminals is shown. For initial access, after downlink synchronization has been built, the terminal receives downlink TDS-OFDM signals and the signal powers can be estimated by using the PN sequence in the guard interval of the TDS-OFDM symbols. The transmit power can be calculated based on the signal and interference powers. For a better estimate, multiple TDS-OFDM symbols can be used. The transmit power of the terminal can be adjusted by either increasing, or decreasing the transmission power. The adjustment is based according to the power estimates.

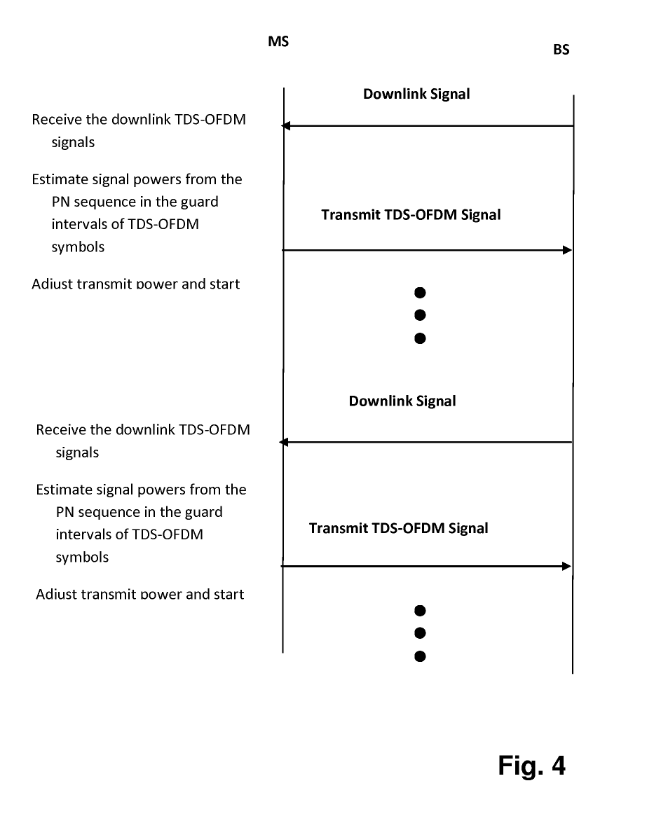

Referring to FIG. 4, open-loop power control for normal operations is shown. For normal operations, the terminal receives downlink TDS-OFDM signals and the signal and/or interference powers can be estimated by using the PN sequence in the guard interval of the TDS-OFDM symbols. The transmit power can be calculated based on the signal powers. For a better estimate, multiple TDS-OFDM symbols can be used. The transmit power of the terminal can be adjusted by either increasing, or decreasing the transmitted power scenarios, based on the power estimates accordingly.

The advantage of using guard sequence instead of the ranging channel method is the removal of ranging channel allocation resources or information to achieve resource-saving results as well as fast control response which is very critical in mobile communications.

As can be seen, the present invention relates to a TDS-OFDM communication system. Both uplink and downlink use TDS-OFDM signals. In a frame time, the transmitted signal is composed of preambles, downlink sub-frames, and uplink sub-frames. The preamble may consist of one or several symbols. Both the downlink and uplink sub-frame consists of multiple OFDM symbols. A downlink OFDM symbol consists of a guard interval and a data part. In an uplink, the bandwidth is divided into multiple sub-bands. Each user uses the radio resource allocated in time-frequency domain. The transmitted signal in each sub-band is composed of multiple OFDM symbols, where each OFDM symbol consists of a guard sequence and OFDM data. Both the guard sequence and data are band-limited to the assigned sub-band. The guard sequence in the guard intervals of the OFDM symbols of the received TDS-OFDM signals in the downlink can be used to estimate the received signal and interference powers. The estimated power of the received TDS-OFDM signal can be used to estimate the path loss of the receiving channel. The estimated received path loss can be used to control terminal transmit power to increase or decrease the terminal transmit powers, for both the initial access and normal operated terminals.

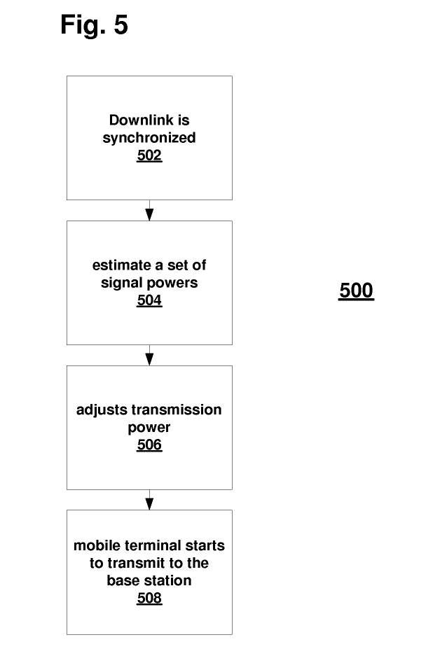

Referring to FIG. 5, a flowchart 500 for open-loop power control on initial access terminals is shown. Downlink is synchronized by receiving a downlink signal from a base station to a mobile terminal (Step 502). The mobile terminal or station, in turn, receives the downlink TDS-OFDM signals and estimate a set of signal powers from the PN sequence in the guard intervals of TDS-OFDM symbols (Step 504). According to the estimate, the mobile terminal adjusts its transmission power (Step 506). The mobile terminal starts to transmit to the base station (Step 508).

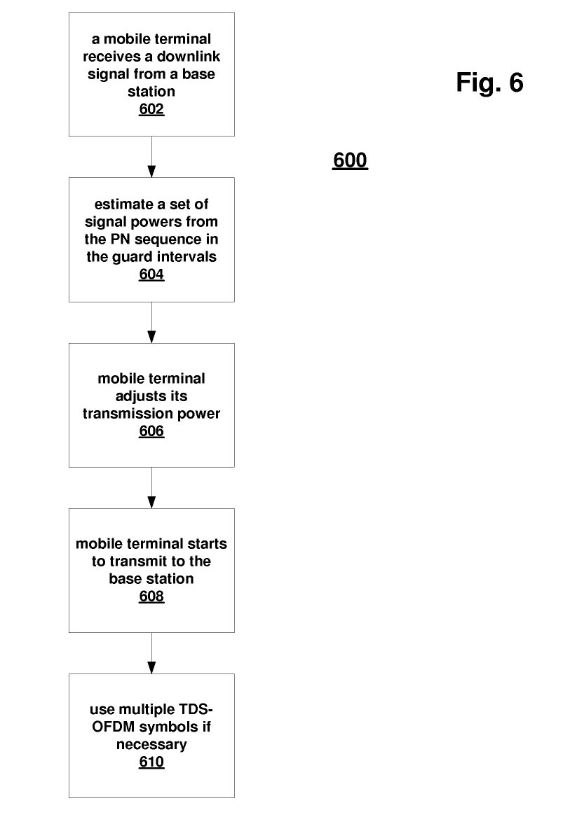

Referring to FIG. 6, a flowchart 600 for open-loop power control on normal operations is shown. Similar to initial access as shown in FIG. 5, but having established downlink synchronization, a mobile terminal receives a downlink signal from a base station (Step 602). The mobile terminal or station, in turn, receives the downlink TDS-OFDM signals and estimate a set of signal powers from the PN sequence in the guard intervals of TDS-OFDM symbols (Step 604). According to the estimate, the mobile terminal adjusts its transmission power (Step 606). The mobile terminal starts to transmit to the base station at the estimated power level (Step 608). For a better estimate, use multiple TDS-OFDM symbols if necessary (Step 610).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A TDS-OFDM communications system comprising:
a frame such that within a frame time, a transmitted signal comprising a preamble,
a downlink sub-frame, and an uplink sub-frame; and
within the downlink sub-frame, interposed between OFDM symbolsare guard power.

2. The system of claim 1, wherein both uplink and downlink use TDS-OFDM signals.

3. The system of claim 1, wherein both the downlink and uplink sub-frame consists of multiple OFDM symbols.

4. The system of claim 1, wherein the preamble may comprise one or more symbols.

5. The system of claim 1, wherein the preamble may be positioned at front, middle or last part of the frame, or distributed within the frame at different parts.

7. The system of claim 1, wherein a downlink OFDM symbol comprises a guard interval and a data part, within the guard interval at least one guard sequence is used, the guard sequence being at least one time-domain PN sequence.

8. The system of claim 1, wherein for a frequency reuse factor is one (frequency reuse factor=1), the guard sequence and OFDM data may occupy all or a part of an available bandwidth.

9. The system of claim 1, wherein for frequency reuse factor larger than 1 (frequency reuse factor>1), the available bandwidth is divided into at least two sub-bands, where sub-carriers in each sub-band are contiguous having all the sub-carriers joined and grouped together, or each sub-band are distributed having some sub-carriers free from joined and grouped together and be located at any position inside the whole available band.

10. The system of claim 1, wherein in the uplink, a bandwidth is divided into multiple sub-bands.

11. The system of claim 1, wherein the guard sequence and OFDM data occupy whole or partial assigned sub-bandwidth.

12. The system of claim 10, wherein the sub-carriers in each sub-band may be contiguous where all the sub-carriers are adjoined and grouped together.

13. The system of claim 10, wherein the sub-carrier is free from adjoining and positioned at any position inside an available band.

14. The system of claim 1, wherein the transmitted signal in each sub-band comprises multiple OFDM symbols, and wherein each OFDM symbol consists of a guard sequence and OFDM data with both the guard sequence and data are band-limited to the assigned sub-band.

15. The system of claim 1, wherein the guard sequence in the guard intervals of the OFDM symbols of the received TDS-OFDM signals in the downlink is used to estimate the received power.

16. The system of claim 1, wherein the estimated received signal power or the interference power are respectively used to control the mobile terminal transmission power.

17. The system of claim 1, wherein each user uses the radio resource allocated in time-frequency domain.

18. The system of claim 1, wherein the transmitted signal in each sub-band is composed of multiple OFDM symbols, where each OFDM symbol includes a guard sequence and a data section.

19. The system of claim 18, wherein both the guard sequence and data are band-limited to an assigned sub-band and used for the power estimation.

20. A method comprising the step of using a guard sequence in a guard interval of OFDM symbols of the received TDS-OFDM signals in the downlink to estimate a received signal power or an interference power.
